(19) United States
(12) Patent Application Publication
(10) Pub. No.: US 2013/0181024 A1
(43) Pub. Date: Jul. 18, 2013

(54) Optical Support Device

(71) Applicant: Vince S. Warner, Alpine, UT (US)

(72) Inventor: Vince S. Warner, Alpine, UT (US)

(73) Assignee: Field Optics Research, Orem, UT (US)

(21) Appl. No.: 13/743,566

(22) Filed: Jan. 17, 2013

Related U.S. Application Data
(60) Provisional application No. 61/587,444, filed on Jan. 17, 2012.

(51) Int. Cl. G02B 7/00; F16M 13/04

(52) U.S. Cl. CPC G02B 7/002; F16M 13/04
USPC 224/576; 248/205.1

(57) ABSTRACT

Disclosed herein are embodiments of a device for transferring the weight of an optical device to the body of the person using that optical device. In some devices, a support harness with shoulder straps is used to bear the weight of the optical device transferred by a support frame. The support frame may be temporarily attached to the optical device and/or support harness for easy assembly and disassembly. In some embodiments, the support harness is collapsible into a compact size.

### CROSS-REFERENCES TO RELATED APPLICATIONS

The present application claims priority as a non-provisional perfection of prior filed U.S. provisional application No. 61/587,444, filed Jan. 17, 2012, and incorporates the same by reference in its entirety herein.

### FIELD OF THE INVENTION

The disclosure relates to optical systems and elements, in particular to supports for optical devices.

### BACKGROUND OF THE INVENTION

Enjoying the outdoors is a pastime for many individuals. Users of optical devices, such as binoculars or cameras, at times desire to support those devices at eye level without using their hands, especially when the optics are used for an extended period of time, such as while bird-watching or hunting. Extended use of optics can lead to fatigue which causes shaky hands and arms, degrading the image being viewed through the optics. Even without fatigue some hands and arms are less steady than others, and a personal, portable mechanism is desired that provides a steady image and better enables extended viewing through the optics.

The present invention is an article support, primarily for optical equipment like binoculars or cameras, whereby the weight of the supported article is transmitted onto the torso of the user while the article itself is held proximate the face of the user.

### SUMMARY OF THE INVENTION

The present invention's general purpose is to provide a support for articles, such as optical devices, that will hold the articles in a vicinity of the user's face while placing at least a majority of the weight of the article on the user's torso. It is also desirable that the support be hands-free when fully deployed and that the article will be held in a secure and stable manner. To accomplish these objectives, the present invention comprises a harness worn by the user. The harness may be a backpack adapted to the purposes of the invention or may be a specialized harness. The invention also comprises a frame attachable to the article and to the harness. An exemplary frame consists of a plurality of legs extending from an adapter fitted to the article and positioned in pockets or similar structures on the harness. Support straps also connect the adapter (or article itself) to the harness at a location above the legs, thereby providing the stability necessary to hold the article in place. Specialized adapters are provided for binoculars and cameras, though it is conceivable that any article desired to be so held could have an appropriate adapter constructed to accommodate use with the invention.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a front elevation of an embodiment with a support harness and a support frame including two support legs.

FIG. 2 is a perspective view of support legs for the support frame of FIG. 1, alternately attached to a camera support and a binocular support.

FIG. 3 illustrates the embodiment of the mechanism for attaching the support frame to binoculars shown in FIG. 2.

FIG. 4 illustrates a bottom view of the attachment mechanism from FIG. 3.

FIG. 5 is a collection of views of the binocular support of FIG. 2.

FIG. 6 is a perspective view of the attachment mechanism of FIG. 3.

FIG. 7 is two perspective views of a first leg adapter for use with the support frame of FIG. 2.

FIG. 8 is a perspective view of a second leg adapter for use with the support frame of FIG. 2.

FIG. 9 illustrates the back of the harness from FIG. 1 equipped with a pack.

### DETAILED DESCRIPTION OF PREFERRED EMBODIMENTS

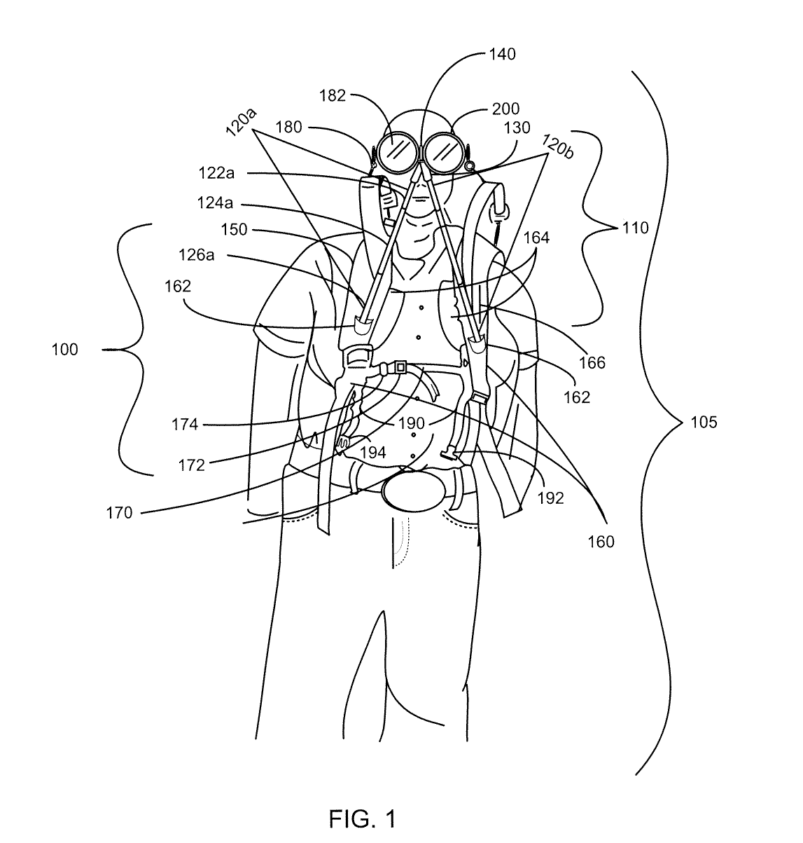

FIG. 1 shows an embodiment of the present invention for use in supporting binoculars 200. This embodiment transfers the weight of the binoculars 200 to the user's 105 torso, which can more easily bear the weight of the binoculars 200 than the head, neck, or arms. Other embodiments may transfer the weight to other locations below the user's 105 neck. The support device 100 in this embodiment comprises a support frame 110 resting on a support harness 150 worn by the user 105, such that the support device 100 transfers weight from the binoculars 200 to the torso of the user 105.

In this embodiment, the support frame 110 includes two supporting legs 120a and 120b that decline in an inverted ‘V’ shape from a vertical support element 130. The top of the vertical support element comprises a means 140 of coupling the support frame 110 to the binoculars 200. The legs 120 distribute the weight of the binoculars 200 down to the support harness 150, on which they are resting. The legs 120 are attached to one another and to the vertical support element 130, such that the legs 120 can be easily spread into an inverted V-shape when the system is in use or can be closed flush against one another for storage.

In some embodiments, it is preferable that the support frame 110 be collapsible, so it can be stored in a small space. In the illustrated embodiment, the supporting legs 120 are foldable. Each supporting leg comprises three segments that are approximately evenly sized. On the first supporting leg 120a, the segments are labeled 122a, 124a, and 126a. The second supporting leg 120b contains identical unlabeled segments. An elastic thread (not shown) holds the segments 122, 124, and 126 together and prevents their separation, but the thread can be stretched to allow sufficient separation of the segments 122, 124, and 126 for the legs to be folded down into a collapsed position. In alternative embodiments, the legs 120 are telescoping and can be collapsed into themselves, or modularly and manually attached to one another to achieve the desired length. These embodiments allow for the quick assembly of the support frame 110 when its use is desired and quick disassembly when its use is not.

The support harness 150 of this embodiment has two shoulder straps 160 that are worn over the shoulders and under the arms of the user like ordinary backpack straps. Like ordinary backpack straps, the portions of the shoulder straps 160 in direct contact with the user's 105 body may be padded with other portions unpadded. Small support pockets 162 on each shoulder strap 160 hold the legs 120 in place and bear the weight of the binoculars 200 and support frame 110 when the support frame 110 is in use. An advantage of small pockets 162 is that the legs 120 can easily be slid into or removed from the small pockets 162, but the legs 120 will remain in place when the binoculars 200 and support frame 110 are in use. This aids in the quick assembly and disassembly of the device. Another embodiment uses two or more D-rings attached to the shoulder straps 160 instead of small pockets 162 to bear the weight of the support frame 110.

In other embodiments, each shoulder strap 160 has a clip on the front and back that attaches the shoulder straps to the user's 105 belt or pants. In those embodiments, the length of the shoulder straps 160 may be adjustable where the straps clip onto the belt or pants. Alternatively, the length of the shoulder straps 160 may be adjustable at the point where the unpadded portion of the shoulder straps attaches to the padded portion. In these embodiments, the position where the legs 120 meet the shoulder straps 160 is adjustable up or down by tightening the strap in the back and loosening the strap in the front or vice versa. This adjustment enables the raising or lowering of the support frame 110 and binoculars 200.

A pair of adjusting straps 170 connect the shoulder straps 160 together. The adjusting straps 170 may be clipped together via the female 172 and male 174 clips threaded on to the adjusting straps 170. The clips 172, 174 can be slid along the adjusting straps 170 to pull the shoulder straps 160 closer together or further apart. In this embodiment, the clips 172, 174 can be slid along the adjusting straps 170 towards the shoulder straps 160 by pulling on the adjusting straps 170 themselves. When the clips 172, 174 are connected to each other and are moved towards the shoulder straps 160, the shoulder straps 160 are pulled closer together. This will raise the front of the binoculars 200 by shrinking the angle between the legs 120. The user can then see higher objects with the same head position. Similarly, loosening the adjusting straps 170 will lower the front of the binoculars 200.

Attached to the top of the shoulder straps 160 are two holding straps 180. The holding straps 180 hold the binoculars 200 flush against the users face when the support frame 110 is in use. When the support frame 110 is not in use, the holding straps 180 allow the binoculars 200 to lay against the user's 105 chest without any other support. Each strap 180 has a clip 182 that connects the strap 180 to the binoculars 200. In some embodiments, the clip 182 can slide along the holding strap 180. When the clip 182 is slid closer to the user's shoulders, and the support frame 110 is in use, the binoculars 200 will hold flush against the user's 105 face. Sliding the clip 182 away from the user's 105 shoulders allows room for the user 105 to remove the supporting legs 120 from the small pockets 162 to prepare for stowage. In other embodiments, the holding strap 180 will be adjustable to different lengths at the point where it 180 connects to the shoulder straps 160. The binoculars 200 can still be adjusted to be flush with the user's 105 face or away from it.

Some embodiments may have storage pockets 164 on one or both shoulder straps 160 that allow for the support frame 110 to be stowed when it is not in use. In the embodiment illustrated, the pockets 164 may be closed using a zipper 166. Embodiments may also have camera straps (not shown) attached to the shoulder straps 160. The camera straps would each have a clip or other means of attachment to a camera, so the camera does not need to be held when the binoculars 200 and support device 100 are in use.

Sternum straps 190 attached to each shoulder strap are shown disconnected from each other. When the support frame 110 is not in use, the binoculars 200 lay against the user's chest supported by the holding straps 180. The adjusting strap 170 then lays beneath the binoculars 200. The sternum straps 190 may be fastened to each other over the binoculars 200 to hold the binoculars 200 against the user's 105 chest and prevent undesired movement. The sternum straps 190 are threaded through female 192 and male 194 clips that can connect the sternum straps 190 to each other. The clips 192, 194 can be slid along the adjusting straps 190 to hold the binoculars 200 tightly against the user's chest.

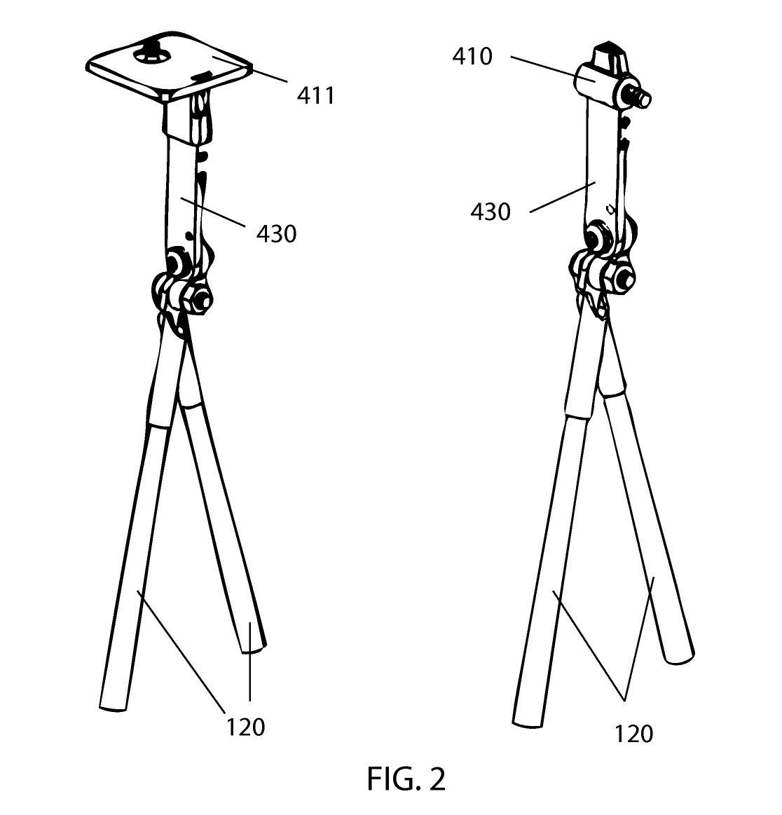

The adjusting 170, holding 180, camera, and sternum straps 190 are sewn onto the shoulder straps 160 in some embodiments. In other embodiments, they may be attached using any method known in the art. It should be noted, as shown in FIG. 2, the support frame 110 may be connected to a connecting rod for a binocular support 410, as is described below, or a camera support 411. While the invention is, for the most part, described in reference to binoculars, both of these embodiments are within the purview of the invention, as is any embodiment later developed for other articles whereby it would be advantageous to support the article in a manner like that shown in this specification.

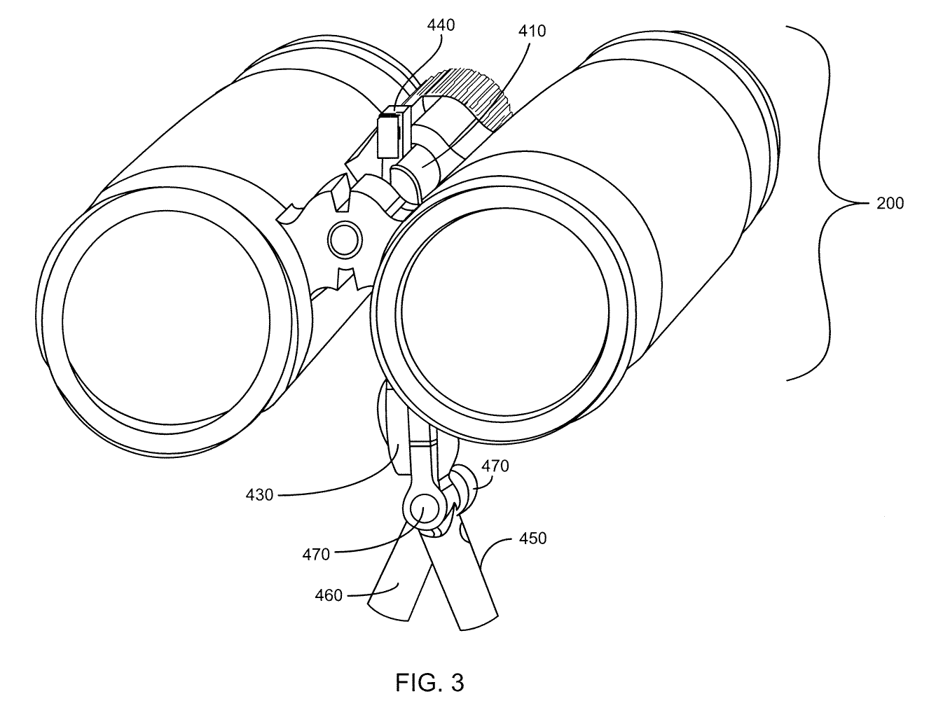

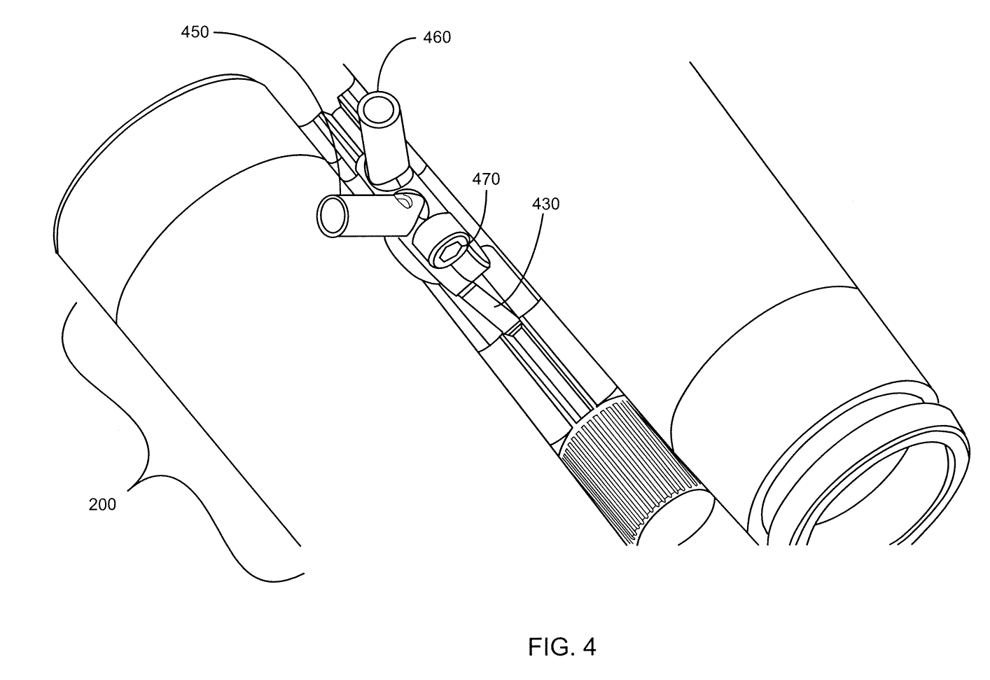

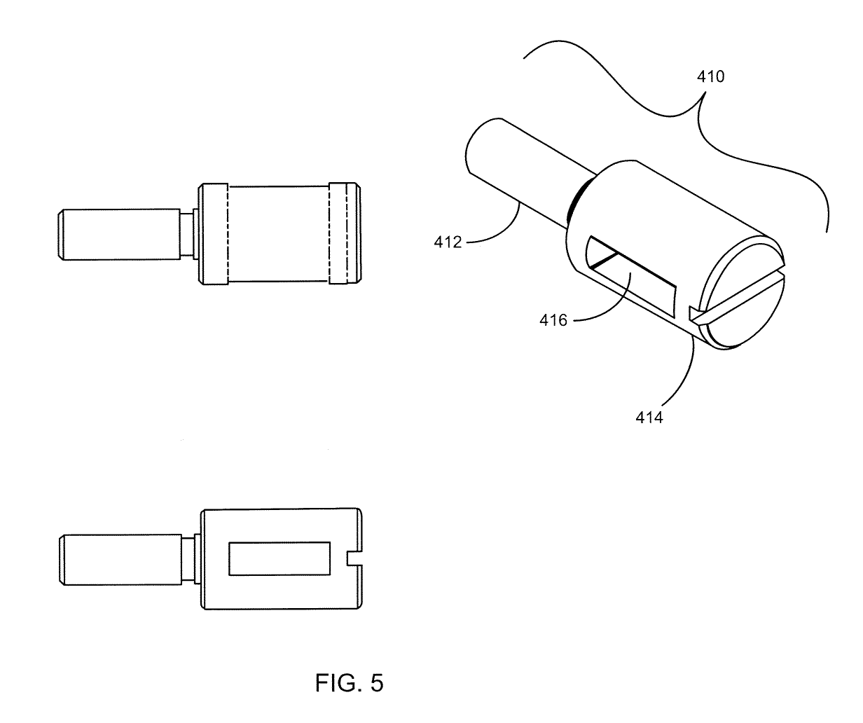

FIGS. 3-8 show an embodiment of the connecting means 440, vertical support 430, and connecting rod 410. This embodiment is described in more detail in co-pending application Ser. No. 13/743,537, entitled Article Supports and Adapters Therefor and filed on Jan. 17, 2013. This co-pending application is incorporated by reference in its entirety herein. The connecting rod 410 is shown in detail in FIG. 5. The connecting rod 410 is cylindrical and includes a narrow end 412 that can be inserted into and attached to the binoculars 200 using any means known in the art such as by screwing if the narrow end 412 is threaded. A wider end 414 is exposed for connection to the support frame 110. A notch 416 in the wider end 414 allows the connecting means 440 to be attached to the connecting rod 410.

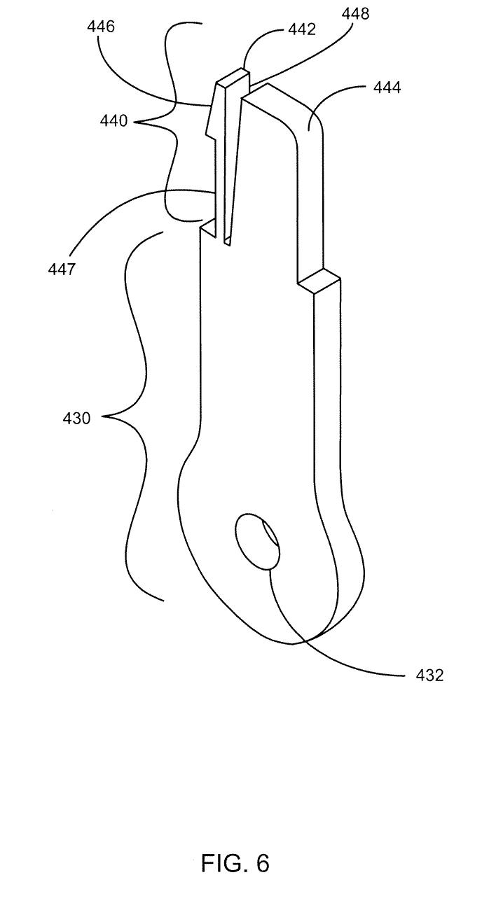

FIG. 6 shows the connecting means 440 and vertical support element 430. The connecting means 440 is designed to snap into the notch 416 of the connecting rod 410. Accordingly, the connecting means 440 includes narrower 442 and wider 444 tabs extending from the vertical support element 430 in parallel with a gap 448 between them. The narrower tab 442 contains a trapezoidal shaped end 446. Where the trapezoidal shape 446 is widest, the width of the narrower tab 442, gap 448, and wider tab 444 should be larger than the notch 416. At the trapezoidal shape's 446 narrowest, the width of the narrower tab 442, gap 448, and wider tab 444 should be smaller than the notch. The non-trapezoidal section 447 of the narrower tab 442 should be slightly longer than the depth of the notch 416.

The connecting means 440 may be made from a rigid material such that the narrower tab 442 is still somewhat flexible and may be squeezed towards the wider tab 444 to allow the connecting means 440 to fit into the notch 416. The notch 416 may apply the pressure to squeeze the narrower tab 442 closer to the wider tab 444 as the notch 416 is slid along the trapezoidal end 446 in the direction of increasing width. This will allow the connecting means 440 to enter the notch 416. Once in the notch 416, the connecting means 440 will be too wide to be removed without pressing the narrower tab 442 towards the wider tab 444. The material for the tabs 442 and 444 should be rigid enough to prevent the narrower tab 442 from moving towards the wider tab 444 without being squeezed. This will prevent the connecting means 440 from being unintentionally dislodged from the connecting rod 410.

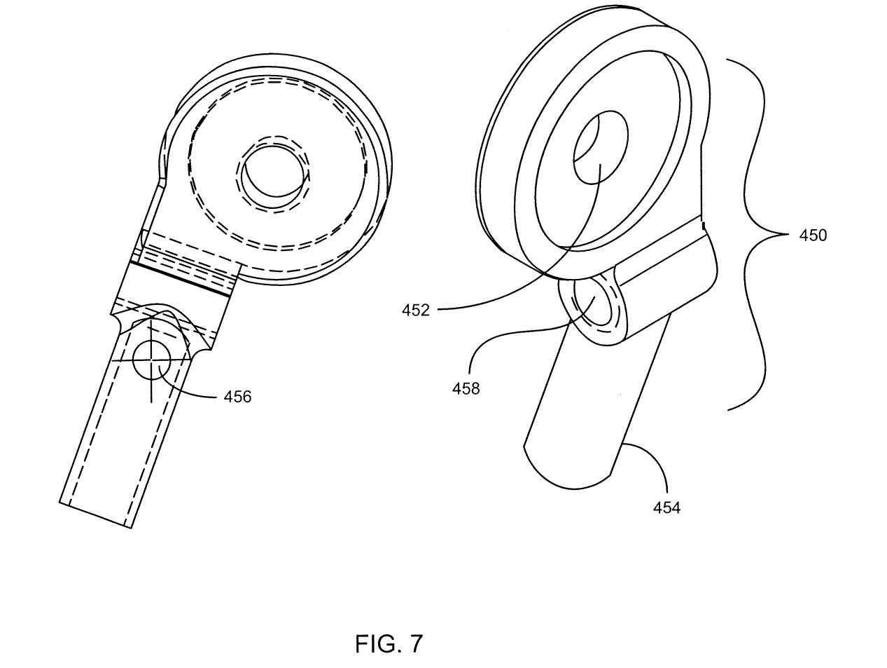

FIG. 7 shows a first leg adapter 450 that connects one leg 120 of the support frame 110 with the vertical support element 430. The first leg adapter 450 contains a hole 452 corresponding with a similarly sized hole 432 in the vertical support element 430. A screw, bolt, or any similar affixing means may be placed through the holes 432 and 452 to hold the first leg adapter 450 and vertical support element 430 together. The first leg adapter 450 has a rigid sleeve 454 that encompasses a leg 120a. The leg 120a is permanent affixed 456 with any means known in the prior art. The first leg adapter 450 has an additional connecting sleeve 458 that allows it to be connected to a second leg adapter 460.

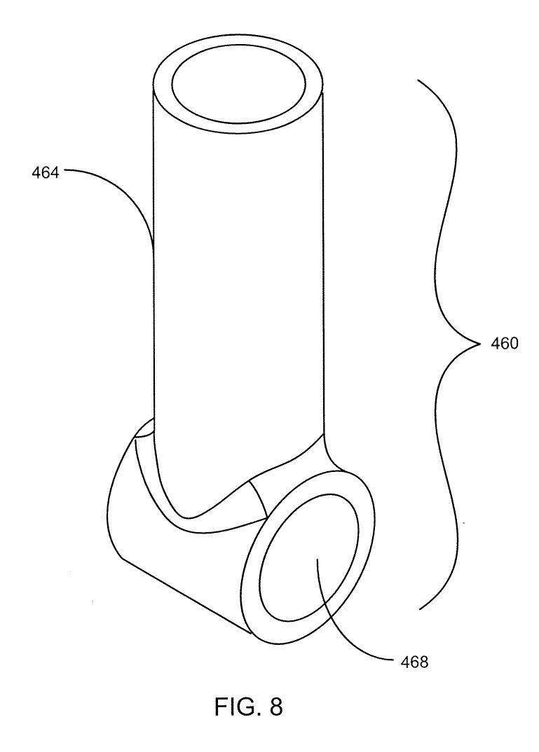

FIG. 8 shows a second leg adapter 460. The second leg adapter 460 also has a rigid sleeve 464 that encompasses the other leg 120b. This leg 120b may be permanently affixed to the second leg adapter 460 in the same manner that the first leg adapter 450 was connected to the first leg 120a or by any other means known in the art. The second leg adapter 460 also has a connecting sleeve 468 that allows it to be connected to the first leg adapter 450. A bolt 470, screw, or any other means known in the art may be inserted into the connecting sleeves 458 and 468 to hold the leg adapters 450 and 460 together.

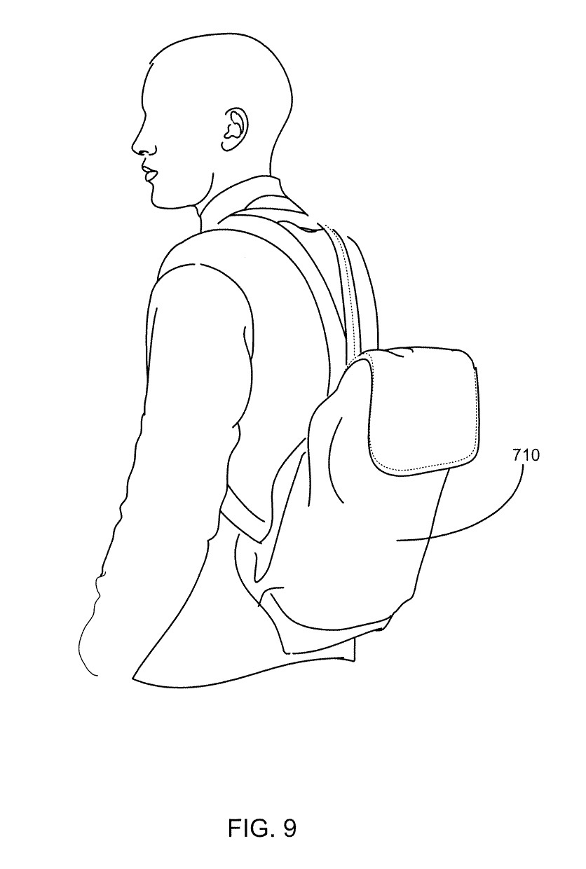

FIG. 9 shows the back of a user wearing the support harness 150. In this embodiment, the support harness 150 has a pack 710 that can be used to stow the user's 105 belongings. In some embodiments, the pack is permanently affixed to the support harness by means known in the art. In other embodiments, the pack 710 is temporarily affixed to the support harness 150 using clips (not shown) or any other means known in the art. The pack 710 can then be removed by the user 150 if not needed or desired. The pack 710 shown is similar to that of an everyday backpack. In other embodiments, a pack of any shape known in the art may be attached (permanently or temporarily) to the shoulder harness.

It will be obvious to those having skill in the art that many changes may be made to the details of the above-described embodiments without departing from the underlying principles of the invention. The scope of the present invention should, therefore, be determined only by the following claims.

I claim:

1. A support device for an optical device comprising a support frame having two or more ends, wherein one or more ends are attached to an optical device and one or more ends are attached to a person at a location below the neck.

2. The support device of claim 1, wherein the support frame is collapsible.

3. The support device of claim 1, the support frame further comprising two or more legs.

4. The support device of claim 1 further comprising:
a. a rod attached to the optical device, wherein the rod comprises a notch, and
b. a means of connecting the rod and the support frame, wherein the means of connecting the rod and the support frame can be inserted into the notch and must be squeezed to be removed from the notch.

5. The support device of claim 1 further comprising a support harness worn by the person, wherein the support harness attaches the support frame to the person.

6. The support device of claim 5, the support harness further comprising small pockets to connect the support frame to the support harness.

7. The support device of claim 5, the support harness further comprising D-rings to connect the support frame to the support harness.

8. The support device of claim 5, the support harness further comprising storage pockets large enough to contain the support frame.

9. The support device of claim 5, the support harness further comprising a pack.

10. The support device of claim 9, wherein the pack is temporarily attached to the support harness.

11. The support device of claim 5, the support harness further comprising one or more shoulder straps that rest on the person's shoulders.

12. The support device of claim 11, the support harness further comprising one or more holding straps, wherein one end of each holding strap is attached to a respective shoulder strap and the other end of each holding strap is attached to the optical device.

13. The support device of claim 5, the support harness further comprising two or more shoulder straps that rest on the person's shoulders.

14. The support device of claim 13, the support harness further comprising two or more adjusting straps, wherein an end of each adjusting strap is attached to a respective shoulder strap and another end is equipped with a means of temporary attachment to other adjustment straps.

15. A method of supporting an optical device comprising:
a. supporting the weight of an optical device with a support frame and
b. supporting the weight of the support frame from below the neck on the body of a person using the optical device.

16. The method of claim 15, wherein the support frame is collapsible.

17. The method of claim 15, wherein the support frame comprises two or more legs.

18. The method of claim 15, wherein the weight of the support frame is supported by a support harness worn by the person.

19. The support harness of claim 18 further comprising small pockets to connect the support frame to the support harness.

20. The support harness of claim 18 further comprising D-rings to connect the support frame to the support harness.
